(19) United States
(12) Patent Application Publication
(10) Pub. No.: US 2025/0018375 A1
(43) Pub. Date: Jan. 16, 2025

(54) CATALYST FOR LOW-TEMPERATURE CARBON MONOXIDE PURIFICATION, METHOD FOR MANUFACTURING THE SAME, AND METHOD FOR PURIFYING CARBON MONOXIDE USING THE SAME

(71) Applicant: KOREA INSTITUTE OF SCIENCE AND TECHNOLOGY, Seoul (KR)

(72) Inventors: Chan KIM, Seoul (KR); Yu-Jin LEE, Seoul (KR); Jaewon KIRK, Seoul (KR); Hyangsoo JEONG, Seoul (KR); Yong Min KIM, Seoul (KR); Hyuntae SOHN, Seoul (KR); Suk Woo NAM, Seoul (KR)

(21) Appl. No.: 18/767,792

(22) Filed: Jul. 9, 2024

(30) Foreign Application Priority Data
Jul. 14, 2023 (KR) 10-2023-0091712

(51) Int. Cl. B01J 21/06; B01J 21/04; B01J 23/00; B01J 23/46; C01B 3/58

(52) U.S. Cl. CPC B01J 21/063; B01J 23/002; B01J 23/462; B01J 21/04; B01J 2523/31; B01J 2523/47; B01J 2523/821; C01B 3/583; C01B 2203/044; C01B 2203/1614

(57) ABSTRACT

Disclosed herein are a catalyst for low-temperature carbon monoxide purification, a method for manufacturing the same, and a method for purifying carbon monoxide using the same. The catalyst comprises a metal oxide carrier; a transition metal oxide primarily supported on the carrier, and ruthenium secondarily supported on a carrier carrying the transition metal oxide. The catalyst provides an effect capable of purifying carbon monoxide contained in a hydrogen gas at a low temperature.

### CROSS REFERENCE TO RELATED APPLICATION

The present application claims the priority of Korean Patent Application No. 10-2023-0091712 filed on Jul. 14, 2023, the entire contents of which are incorporated herein by reference.

### BACKGROUND OF THE INVENTION

### Field of the Invention

The present disclosure relates to a catalyst for low-temperature carbon monoxide purification, a method for manufacturing the same, and a method for purifying carbon monoxide using the same.

### DESCRIPTION OF GOVERNMENT-SPONSORED RESEARCH

This research was conducted at the Korea Institute of Science and Technology by the management of the Korea Institute of Science and Technology under the Ministry of Science and ICT. The research project name is the support for research and operation expenses (Main Project Cost) of the Korea Institute of Science and Technology, and the research project task name is the development of green hydrogen production-liquid storage integration technology (Project identification number: 1711203714, Project number: 2E32590).

Also, this research was conducted at the Uiwang Research Institute of Hyundai Motor Co., Ltd. by the management of the Korea Planning & Evaluation Institute of Industrial Technology under the Ministry of Trade, Industry and Energy. The research project name is the material component technology development, and the research project task name is the development of a hydrogen fuel cell-based power source for wheeled armored vehicles (Project identification number: 1415185306, Project number: 20019144).

### Description of the Related Art

A partial oxidation process of carbon monoxide (PROX, preferential CO oxidation reaction), which is used industrially to purify carbon monoxide, requires an O₂ blower to blow oxygen. However, there is a limit to process efficiency due to the high cost to operate to it. Additionally, in order to obtain hydrogen used as a PEMFC (Polymer Electrolyte Membrane Fuel Cell) fuel, the remaining O₂ must be removed again. Hydrogen for the PEMFC fuel requires an expensive purification process because it needs to ensure a purity of 99.997%.

A methanation process that is mainly used instead of the PROX process for purification of carbon monoxide requires a high operating temperature (˜200° C.), which also requires an additional heat source. Therefore, there are clear limitations in applying the PEMFC to vehicles where it is mainly used.

### SUMMARY OF THE INVENTION

In an aspect, the purpose of the present disclosure is to provide a catalyst for purification of carbon monoxide contained in a reformed gas.

In other aspect, the purpose of the present disclosure is to provide a method for manufacturing a catalyst for purifying carbon monoxide contained in a reformed gas.

In another aspect, the purpose of the present disclosure is to provide a method for purifying carbon monoxide contained in a reformed gas using a catalyst for purifying carbon monoxide contained in the reformed gas.

In still another aspect, the purpose of the present disclosure is to provide an apparatus for purifying carbon monoxide contained in a reformed gas using a catalyst for purifying carbon monoxide contained in the reformed gas.

In an aspect, the present disclosure provides a catalyst for purifying carbon monoxide contained in a reformed gas, comprising: a metal oxide carrier; a transition metal oxide primarily supported on the carrier; and ruthenium secondarily supported on a carrier carrying the transition metal oxide.

In an exemplary embodiment, the metal oxide carrier may be one or more selected from the group consisting of silica, alumina, magnesia, titania, and zirconia.

In an exemplary embodiment, the transition metal oxide may be one or more oxides selected from the group consisting of Ti, Ce, Ni, and Rh.

In an exemplary embodiment, the transition metal oxide may be contained in an amount of 0.1 to 20% by weight based on the total weight of the catalyst.

In an exemplary embodiment, the ruthenium may be contained in an amount of 0.1 to 20% by weight based on the total weight of the catalyst.

In an exemplary embodiment, the reformed gas may contain 0.0001 to 32 vol % of carbon monoxide based on the total volume of the reformed gas, hydrogen in a volume fraction equivalent to twice or more the volume fraction of carbon monoxide, and 95 vol % or less of an inert gas other than hydrogen based on the total volume of the reformed gas.

In an exemplary embodiment, the catalyst can purify carbon monoxide contained in the reformed gas at 80 to 180° C.

In other aspect, the present disclosure provides a method for manufacturing the catalyst for purification of carbon monoxide contained in the reformed gas, the method comprising the steps of: (1) adding a precursor solution of the transition metal oxide to the metal oxide carrier, followed by drying and calcining to obtain a carrier carrying the transition metal oxide; and (2) adding a precursor solution of ruthenium to the carrier carrying the transition metal oxide, followed by drying.

In an exemplary embodiment, the drying in step (1) may be performed using a rotary evaporator.

In an exemplary embodiment, the calcination in step (1) may be performed at 300 to 600° C. for 1 to 5 hours.

In an exemplary embodiment, the drying in step (2) may be performed at 30 to 60° C. for 15 to 30 hours.

In another aspect, the present disclosure provides a method for purifying carbon monoxide contained in a reformed gas using the catalyst for purifying carbon monoxide contained in the reformed gas, the method comprising the step of passing the reformed gas containing hydrogen and carbon monoxide through a reactor containing the catalyst.

In an exemplary embodiment, the method may comprise passing the reformed gas through a low-temperature reactor of 110 to 120° C. containing the catalyst, and then passing it through a high-temperature reactor of 140° C. or higher containing the catalyst.

In an aspect, the technology disclosed in the present disclosure has an effect of providing a catalyst for purification of carbon monoxide contained in a reformed gas.

In other aspect, the technology disclosed in the present disclosure has an effect of providing a method for manufacturing a catalyst for purifying carbon monoxide contained in a reformed gas.

In another aspect, the technology disclosed in the present disclosure has an effect of providing a method for purifying carbon monoxide contained in a reformed gas using a catalyst for purifying carbon monoxide contained in the reformed gas.

In still another aspect, the technology disclosed in the present disclosure has an effect of providing an apparatus for purifying carbon monoxide contained in a reformed gas using a catalyst for purifying carbon monoxide contained in the reformed gas.

### BRIEF DESCRIPTION OF THE DRAWINGS

FIG. 1 shows a schematic diagram of a method for manufacturing a catalyst according to an embodiment.

FIG. 2A shows a photograph of a catalyst (TiO₂/Al₂O₃) having titanium oxide supported on an alumina carrier.

FIG. 2B shows a photograph of a catalyst (Ru/TiO₂/Al₂O₃) having Ru dispersed in TiO₂/Al₂O₃.

FIG. 3 shows a schematic diagram of an apparatus for purifying carbon monoxide according to an embodiment.

FIG. 4 shows a schematic diagram of selectivity of a product for each temperature of a catalyst according to the present disclosure.

FIG. 5A shows a conversion rate of carbon monoxide for each temperature by the purification reaction of carbon monoxide in an experimental embodiment using catalysts according to Example 1 and Comparative Example 1.

FIG. 5B shows a production rate of long-chain hydrocarbon for each temperature by the purification reaction of carbon monoxide in an experimental embodiment using catalysts according to Example 1 and Comparative Example 1.

FIG. 5C shows a reaction rate and a residual amount of carbon monoxide for each temperature by the purification reaction of carbon monoxide in an experimental embodiment using a catalyst according to Comparative Example 1.

FIG. 5D shows a reaction rate and a residual amount of carbon monoxide for each temperature by the purification reaction of carbon monoxide in an experimental embodiment using a catalyst according to Example 1.

FIG. 6A shows a conversion rate of carbon monoxide for each temperature by the purification reaction of carbon monoxide in an experimental embodiment using catalysts according to Example 1 and Comparative Example 2.

FIG. 6B shows a decomposition reaction rate of carbon monoxide for each temperature by the purification reaction of carbon monoxide in an experimental embodiment using catalysts according to Example 1 and Comparative Example 2.

FIG. 6C shows a production rate of long-chain hydrocarbon for each temperature by the purification reaction of carbon monoxide in an experimental embodiment using catalysts according to Example 1 and Comparative Example 2.

FIG. 6D shows a production rate of methane for each temperature by the purification reaction of carbon monoxide in an experimental embodiment using catalysts according to Example 1 and Comparative Example 2.

FIG. 7A shows a comparison of production rates of long-chain hydrocarbon and methane by the purification reaction of carbon monoxide in an experimental embodiment using catalysts according to Example 1 and Comparative Example 2.

FIG. 7B shows a comparison of production rates of long-chain hydrocarbon and methane by the purification reaction of carbon monoxide in an experimental embodiment using catalysts according to Example 1 and Comparative Example 2.

FIG. 8A shows a conversion rate of carbon monoxide for each temperature by the purification reaction of carbon monoxide in an experimental embodiment using catalysts according to Examples 1 and 2, and Comparative Example 1.

FIG. 8B shows a decomposition reaction rate of carbon monoxide for each temperature by the purification reaction of carbon monoxide in an experimental embodiment using catalysts according to Examples 1 and 2, and Comparative Example 1.

FIG. 8C shows a production rate of long-chain hydrocarbon for each temperature by the purification reaction of carbon monoxide in an experimental embodiment using catalysts according to Examples 1 and 2, and Comparative Example 1.

FIG. 8D shows a production rate of methane for each temperature by the purification reaction of carbon monoxide in an experimental embodiment using catalysts according to Examples 1 and 2, and Comparative Example 1.

FIG. 9 shows a production amount of long-chain hydrocarbon and methane for each temperature by the purification reaction of carbon monoxide in an experimental embodiment using catalysts according to Examples 1 and 2, and Comparative Example 1.

FIG. 10 shows a decomposition reaction rate of carbon monoxide for each temperature by the purification reaction of carbon monoxide in an experimental embodiment using catalysts according to Example 1 and Comparative Examples 3 to 5.

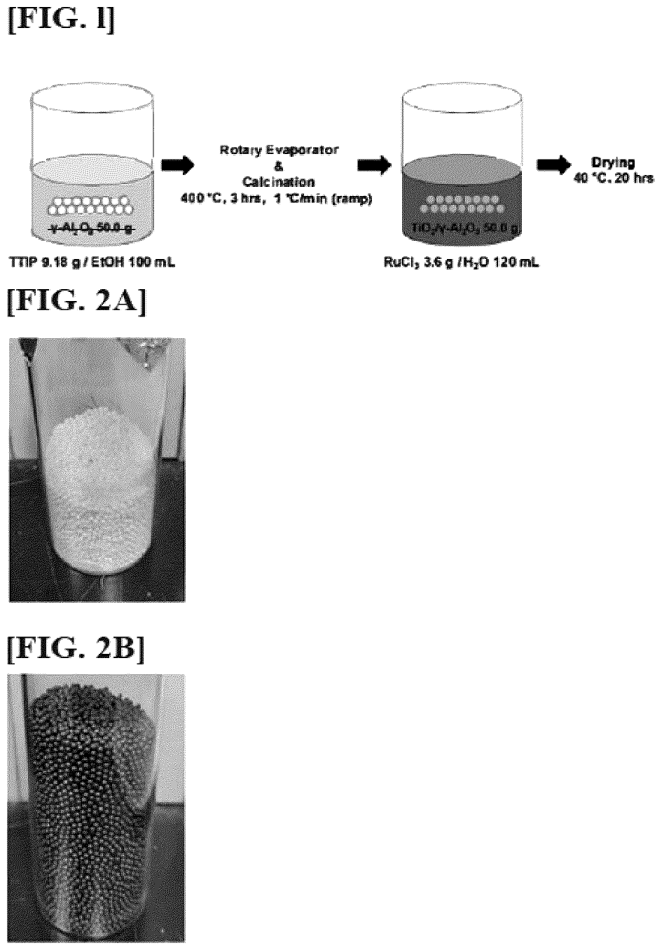

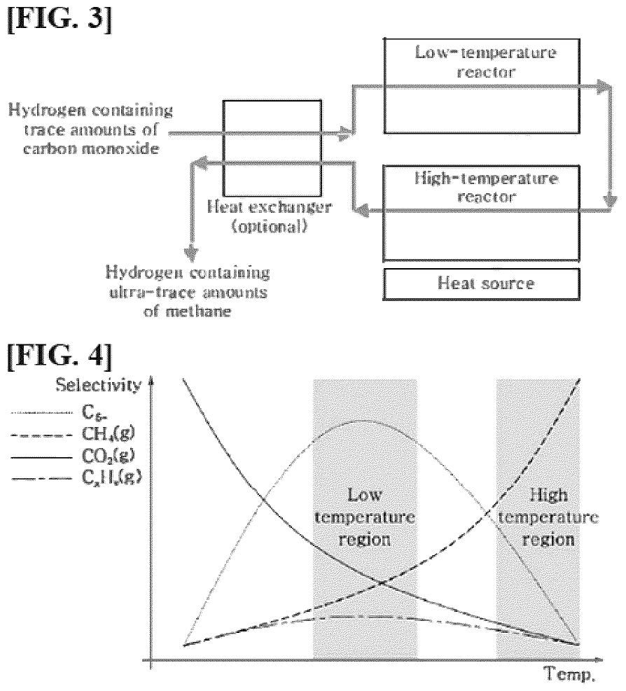

### DETAILED DESCRIPTION OF THE INVENTION

Hereinafter, the present disclosure will be described in detail.

In an aspect, the present disclosure provides a catalyst for purifying carbon monoxide contained in a reformed gas, comprising: a metal oxide carrier; a transition metal oxide primarily supported on the carrier; and ruthenium secondarily supported on a carrier carrying the transition metal oxide.

The catalyst composition comprises ruthenium having activity in the purification reaction of carbon monoxide, a transition metal oxide that helps the activity of ruthenium, and a metal oxide support on which the transition metal oxide and ruthenium are supported.

In an exemplary embodiment, the metal oxide carrier may have a shape, for example, a pellet shape or a bead shape.

In an exemplary embodiment, the metal oxide carrier may be one or more selected from the group consisting of silica, alumina, magnesia, titania, and zirconia.

In an exemplary embodiment, the transition metal oxide may be one or more oxides selected from the group consisting of Ti, Ce, Ni, and Rh. The transition metal oxide can increase a ratio of step-edge shaped Ru active sites by adjusting a size of ruthenium particles in the step supporting the ruthenium particles. In addition, electrons can be donated to Ru through a strong metal-carrier interaction (SMSI) effect, thereby compensating for the electron density that decreases as the size of the Ru particles decreases so that a high decomposition rate of carbon monoxide can be induced.

In an exemplary embodiment, the metal oxide carrier may be alumina and the transition metal oxide may be titanium oxide.

In an exemplary embodiment, the transition metal oxide may be contained in an amount of 0.1 to 20% by weight based on the total weight of the catalyst. In other exemplary embodiment, the transition metal oxide may be present in an amount of 0.1% by weight or more, 0.5% by weight or more, 1% by weight or more, 1.5% by weight or more, 2% by weight or more, 2.5% by weight or more, 3% by weight or more, 3.5% by weight or more, 4% by weight or more, 4.5% by weight or more, or 5% by weight or more, based on the total weight of the catalyst, and may be present in an amount of 20% by weight or less, 19% by weight or less, 18% by weight or less, 17% by weight or less, 16% by weight or less, 15% by weight or less, 14% by weight or less, 13% by weight or less, 12% by weight or less, 11% by weight or less, 10% by weight or less, 9% by weight or less, 8% by weight or less, 7% by weight or less, 6% by weight or less, 5% by weight or less, 4% by weight or less, or 3% by weight or less, based on the total weight of the catalyst.

In an exemplary embodiment, the ruthenium may be contained in an amount of 0.1 to 20% by weight based on the total weight of the catalyst. In another exemplary embodiment, the ruthenium may be present in an amount of 0.1% by weight or more, 0.5% by weight or more, 1% by weight or more, 1.5% by weight or more, 2% by weight or more, 2.5% by weight or more, 3% by weight or more, 3.5% by weight or more, 4% by weight or more, 4.5% by weight or more, or 5% by weight or more, based on the total weight of the catalyst, and may be present in an amount of 20% by weight or less, 19% by weight or less, 18% by weight or less, 17% by weight or less, 16% by weight or less, 15% by weight or less, 14% by weight or less, 13% by weight or less, 12% by weight or less, 11% by weight or less, 10% by weight or less, 9% by weight or less, 8% by weight or less, 7% by weight or less, 6% by weight or less, 5% by weight or less, 4% by weight or less, or 3% by weight or less, based on the total weight of the catalyst.

In an exemplary embodiment, the reformed gas may contain 0.0001 to 32 vol % of carbon monoxide based on the total volume of the reformed gas, hydrogen in a volume fraction equivalent to twice or more the volume fraction of carbon monoxide, and 95 vol % or less of an inert gas other than hydrogen based on the total volume of the reformed gas. The reformed gas essentially contains hydrogen, and the hydrogen is required in a volume equivalent to twice or more the volume of carbon monoxide in order for all carbon monoxide to be purified. Also, the reformed gas may contain 95% by volume or less of the inert gas other than the hydrogen based on the total volume of the reformed gas, or the reformed gas may not contain the inert gas.

In an exemplary embodiment, the catalyst may purify carbon monoxide contained in the reformed gas at 80 to 180° C., 80 to 160° C., 90 to 160° C., 100 to 160° C., or 110 to 160° C. The catalyst according to the present disclosure causes decomposition of carbon monoxide and production of a long-chain hydrocarbon compound with carbon atoms of 5 or more in case the reaction temperature for purifying carbon monoxide is low, and may induce methanation of carbon monoxide in case the reaction temperature for purifying carbon monoxide is high.

The catalyst disclosed in this specification comprises ruthenium particles dispersed on a transition metal oxide supported on a carrier. The catalyst allows the ruthenium particles to evenly disperse to decompose carbon monoxide and produce a hydrocarbon compound at a low temperature of about 100 to 120° C., and induces methanation of carbon monoxide at a high temperature of about 140° C. or higher to enable to obtain hydrogen of high purity by efficiently purifying carbon monoxide.

In an exemplary embodiment, the catalyst is effective in purifying carbon monoxide with high energy conversion efficiency at a low temperature.

In an exemplary embodiment, the catalyst provides an effect of purifying carbon monoxide contained in a hydrogen gas at a low temperature.

In an exemplary embodiment, the catalyst is effective in producing hydrogen for a polymer electrolyte membrane fuel cell (PEMFC) fuel that requires carbon monoxide of extremely low concentration.

In an exemplary embodiment, the catalyst has an effect of saving the cost of a high-purity hydrogen production process.

In other aspect, the present disclosure provides a method for manufacturing the catalyst for purification of carbon monoxide contained in the reformed gas, the method comprising the steps of: (1) adding a precursor solution of the transition metal oxide to the metal oxide carrier, followed by drying and calcining to obtain a carrier carrying the transition metal oxide; and (2) adding a precursor solution of ruthenium to the carrier carrying the transition metal oxide, followed by drying.

In an exemplary embodiment, the drying in step (1) may be performed using a rotary evaporator.

In an exemplary embodiment, the calcination in step (1) may be performed at 300 to 600° C. In other exemplary embodiment, the calcination in step (1) may be performed at a temperature of 300° C. or higher, 350° C. or higher, or 400° C. or higher, and 600° C. or lower, 550° C. or lower, 500° C. or lower, 450° C. or lower, or 400° C. or lower.

In an exemplary embodiment, the calcination in step (1) may be performed at 300 to 600° C. for 1 to 5 hours.

In an exemplary embodiment, the drying in step (2) may be performed at 30 to 60° C. In other exemplary embodiment, the drying in step (2) may be performed at a temperature of 30° C. or higher, 35° C. or higher, or 40° C. or higher, and 60° C. or lower, 55° C. or lower, 50° C. or lower, 45° C. or lower, or 40° C. or lower.

In an exemplary embodiment, the drying in step (2) may be performed at 30 to 60° C. for 15 to 30 hours.

In another aspect, the present disclosure provides a method for purifying carbon monoxide contained in a reformed gas using the catalyst for purifying carbon monoxide contained in the reformed gas, the method comprising the step of passing the reformed gas containing hydrogen and carbon monoxide through a reactor containing the catalyst.

In an exemplary embodiment, a space velocity of the reformed gas may be 100 to 90,000 mL/gcat·hr, 500 to 10,000 mL/gcat·hr, or 1,000 to 5,000 mL/gcat·hr. The space velocity of the reformed gas may vary depending on a fraction of carbon monoxide in the reformed gas.

In an exemplary embodiment, the method may be applied at a temperature range of 50° C. to 300° C. and/or a pressure condition of 1 to 1,200 bar. Each condition may vary depending on the optimal condition according to the fraction of carbon monoxide in the reformed gas.

In an exemplary embodiment, the method may comprise passing the reformed gas through a low-temperature reactor of 110 to 120° C. containing the catalyst, and then passing it through a high-temperature reactor of 140° C. or higher containing the catalyst. The low-temperature region causes decomposition of carbon monoxide and production of a long-chain hydrocarbon compound with carbon atoms of 5 or more, and the high-temperature region acts to completely remove and methanize unreacted carbon monoxide.

In another aspect, the present disclosure provide an apparatus for purifying carbon monoxide contained in a reformed gas using the catalyst for purifying carbon monoxide contained in the reformed gas, the apparatus comprising: the catalyst, a low-temperature reactor of 110 to 120° C., a high-temperature reactor of 140° C. or higher, and a heat source.

Hereinafter, the present disclosure will be described in more detail through Examples. It will be apparent to those skilled in the art that these Examples are merely for illustrating the present disclosure, and that the scope of the present disclosure should not be construed as being limited by these Examples.

### Example 1. Manufacture of Ru3/Ti3/A Catalyst by Sequential Method

TTIP (Titanium Tetraisopropoxide)/anhydrous ethanol solution (TTIP 9.18 g/EtOH 100 mL) was added to 50 g of an alumina carrier. Thereafter, the mixture was dried on a rotary evaporator and then calcined in air at 400° C. for 3 hours to support the transition metal oxide on the alumina carrier. Afterwards, ruthenium chloride (RuCl₃)/purified water solution (RuCl₃ 3.6 g/H₂O 120 mL) was added to 50 g of the carrier carrying the transition metal oxide, and dried at 40° C. for 20 hours to support ruthenium. Finally, a Ru3/TiO₂3/Al₂O₃ catalyst was obtained in which 3% by weight of titanium oxide and 3% by weight of ruthenium were supported in a sequential method.

### Example 2. Manufacture of Ru3/Ti5/A Catalyst by Sequential Method

A catalyst was manufactured in the same manner as that of Example 1, except that TTIP (Titanium Tetraisopropoxide)/anhydrous ethanol solution (TTIP 15.3 g/EtOH 100 mL) was added. Finally, a Ru3/TiO₂3/Al₂O₃ catalyst was obtained in which 5% by weight of titanium oxide and 3% by weight of ruthenium were supported in a sequential method.

### Comparative Example 1. Manufacture of Ru3/A Catalyst

Ruthenium chloride (RuCl₃)/purified water solution (RuCl₃ 3.6 g/H₂O 120 mL) was added to 50 g of an alumina carrier, and dried at 40° C. for 20 hours to support ruthenium. Finally, a Ru3/Al₂O₃ catalyst carrying 3% by weight of ruthenium was obtained.

### Comparative Example 2. Manufacture of Ru3/Ti3/A Catalyst by One Pot Method

A solution of 9.18 g of TTIP (Titanium Tetraisopropoxide) as a transition metal oxide precursor and 3.6 g of ruthenium chloride (RuCl₃) as a ruthenium precursor dissolved in 100 mL of anhydrous ethanol (EtOH) was added to 50 g of an alumina carrier. Afterwards, the mixture was dried on a rotary evaporator and then calcined in air at 400° C. for 3 hours to support the transition metal oxide and ruthenium on the alumina carrier. Finally, a Ru3/TiO₂3/Al₂O₃ catalyst was obtained in which 3% by weight of titanium oxide and 3% by weight of ruthenium were supported in a one pot method.

### Comparative Example 3. Manufacture of Ru/TiO₂-450 Catalyst

After dissolving 1.6 g of ruthenium chloride (RuCl₃) in 30 mL of distilled water, 2.0 g of rutile titanium oxide (Rutile TiO₂) was added to the solution, and the obtained suspension was strongly stirred and dried at 50° C. Afterwards, it was dried at 120° C. overnight and then calcined in air at 300° C. Afterwards, it was washed with 1 mol L⁻¹ of an aqueous ammonia solution, and the washing was repeated by a precipitation method using an aqueous silver nitrate solution (AgNO₃, 0.1 mol L⁻¹) until no residual chloride ions were precipitated. Afterwards, it was dried at 60° C. overnight to obtain a Ru/TiO₂ catalyst. Thereafter, the catalyst was reduced under the conditions of a hydrogen gas (20 mL min⁻¹) and 450° C. Finally, Ru/TiO₂-450 catalyst was obtained.

### Comparative Example 4. Manufacture of Ru/Al₂O₃-450 Catalyst

1.6 g of ruthenium chloride (RuCl₃) was dissolved in 30 mL of distilled water. Thereafter, a suspension in which 2.0 g of an alumina carrier was added to the solution was sonicated for 30 minutes to disperse the metal in the carrier. Afterwards, it was dried at 120° C. overnight and then at 120° C. for 12 hours. Afterwards, it was reduced under the conditions of a hydrogen gas (20 mL min⁻¹) and 450° C. Finally, Ru/Al₂O₃-450 catalyst was obtained.

### Comparative Example 5. Manufacture of 1Ru/TiO₂-450H Catalyst

0.63 g of ruthenium chloride (RuCl₃) was dissolved in 50 mL of distilled water. Afterwards, a suspension in which 2.0 g of rutile titanium oxide (Rutile TiO₂) was added to the solution was strongly stirred and dried at 50° C. Afterwards, it was dried at 110° C. overnight and then calcined in air at 300° C. Afterwards, it was washed with an aqueous ammonia solution of 1 mol L⁻¹, and the washing was repeated by a precipitation method using an aqueous silver nitrate solution (AgNO₃, 0.1 mol L⁻¹) until no residual chloride ions were precipitated. Afterwards, it was dried at 60° C. overnight to obtain a 1Ru/TiO₂ catalyst carrying 1% by weight of ruthenium. Afterwards, the catalyst was reduced under the conditions of a hydrogen gas (20 mL min⁻¹) and 450° C. Finally, 1Ru/TiO₂-450H catalyst was obtained.

### Experimental Example 1. Purification Reaction of Carbon Monoxide

A purification reaction of carbon monoxide contained in a reformed gas was performed using the catalysts obtained by Example 1 and Comparative Example 1 as follows.

Specifically, a reformed gas having a composition of 0.1% CO/99.9% H₂ was reacted with 1 g of the catalyst in a plug flow reactor while changing a temperature under the conditions of an atmospheric pressure and a space velocity of 1,800 mL/h/g_{cat}. Experimental results were calculated from the gas composition obtained using a gas chromatography (8890GC, Agilent Technologies, USA) which was connected to the reactor.

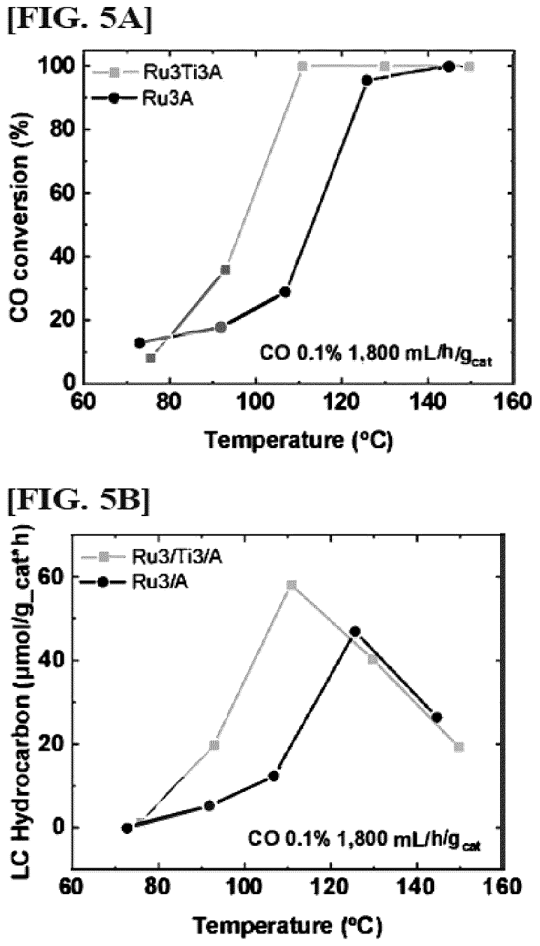

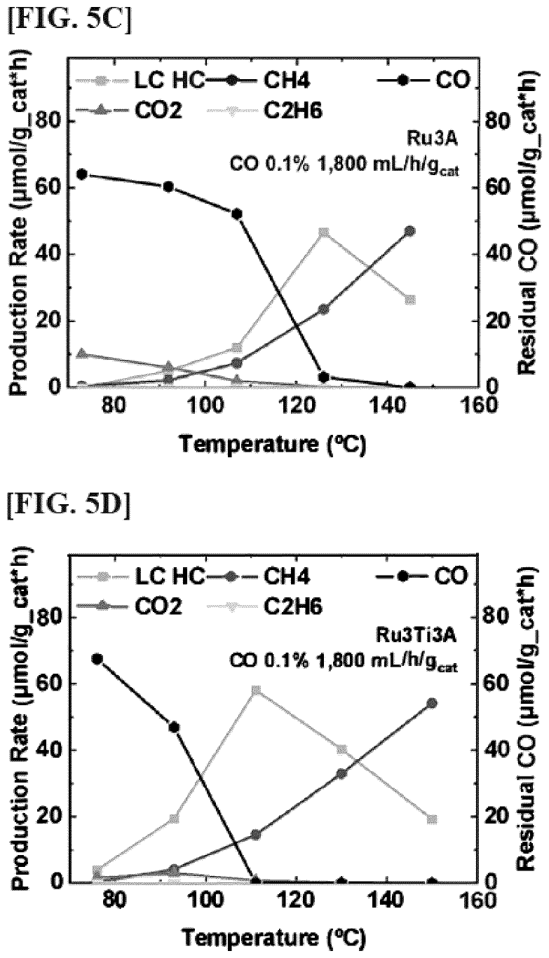

As can be seen in FIGS. 5A to 5D, the catalyst of Example 1 showed a significantly higher conversion rate of carbon monoxide and production rate of a long-chain hydrocarbon (LC HC) of C₅ or more at a low temperature, compared to the catalyst of Comparative Example 1, which results in having a significantly high catalytic activity in the low temperature reaction.

### Experimental Example 2. Purification Reaction of Carbon Monoxide

A purification reaction of carbon monoxide contained in a reformed gas was performed using the catalysts obtained in Example 1 and Comparative Example 2. The reaction was performed in the same manner as that of Experimental Example 1, except that the reformed gas having a composition of CO 836 ppm (0.0836%)/H₂ 99.9164% was used.

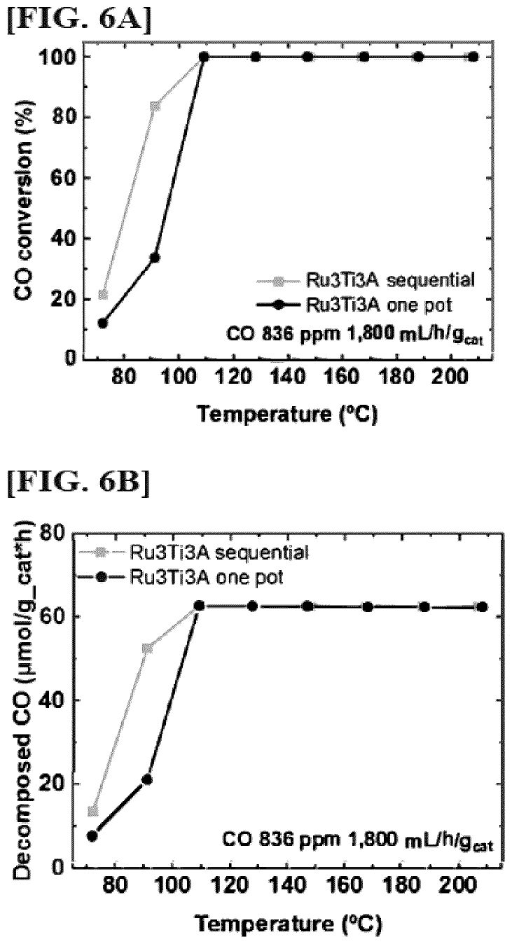

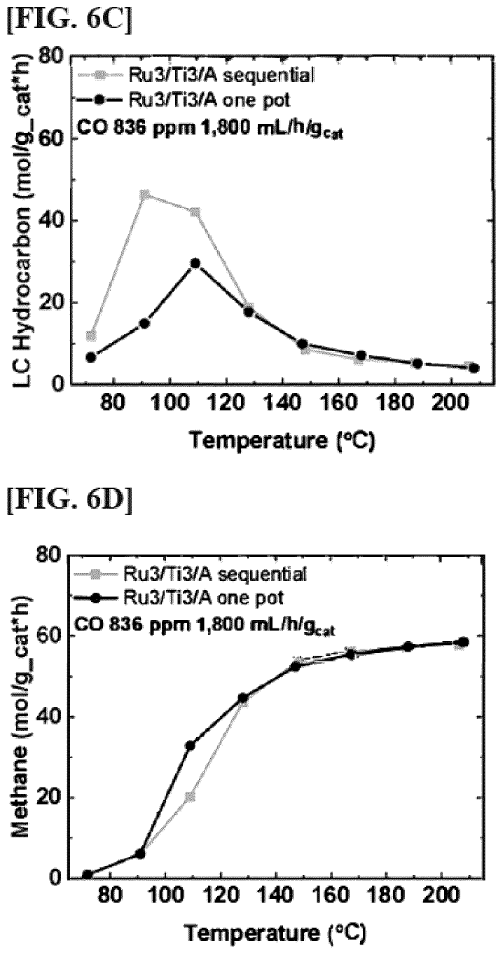

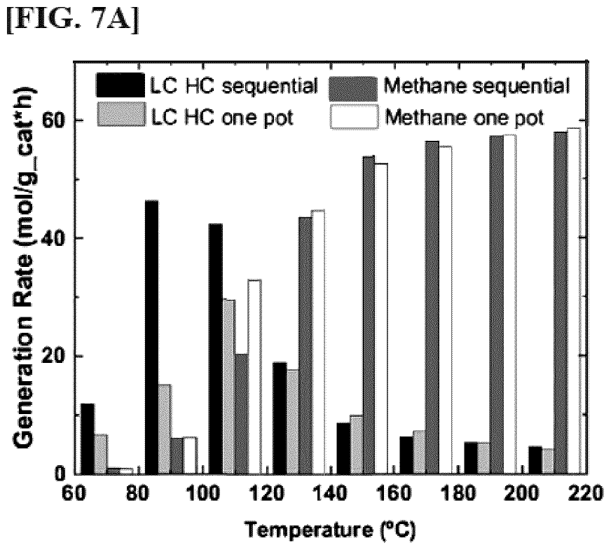

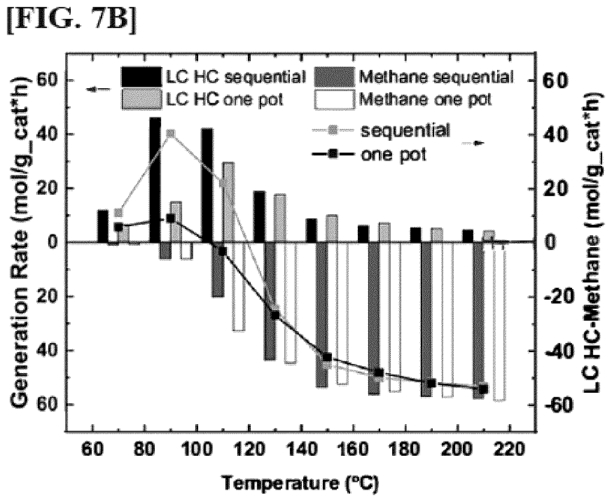

As can be seen in FIGS. 6A to 6D and FIGS. 7A to 7B, the catalyst of Example 1 showed a significantly higher conversion rate of carbon monoxide and decomposition reaction rate of carbon monoxide at a low temperature, compared to the catalyst of Comparative Example 2, which results in having a significantly higher catalytic activity at the low temperature reaction. In addition, the catalyst of Example 1 was found to decompose carbon monoxide at a low temperature and produce a long-chain hydrocarbon of C₅ or more at a very high rate. In the case of the long-chain hydrocarbon compound, commercially available adsorption technologies have sufficiently been developed, and therefore it is important to increase a selectivity for the long-chain hydrocarbon compound. It was confirmed that the catalyst of Example 1 had an excellent selectivity for the long-chain hydrocarbon compound at a low temperature.

### Experimental Example 3. Purification Reaction of Carbon Monoxide

A purification reaction of carbon monoxide contained in a reformed gas was performed using the catalysts obtained in Examples 1 and 2 and Comparative Example 1. The reaction was performed in the same manner as that of Experimental Example 1, except that the reformed gas having a composition of CO 1.0%/H₂ 99.0% was used.

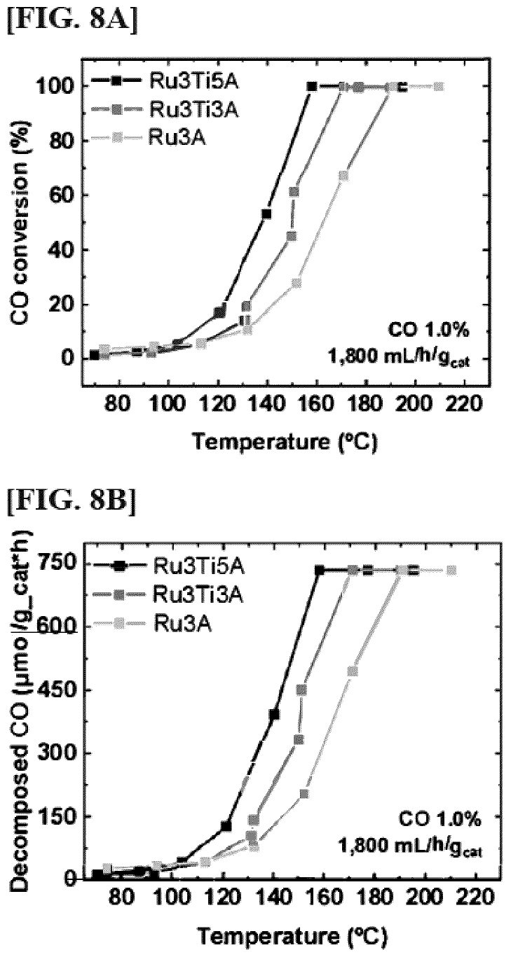

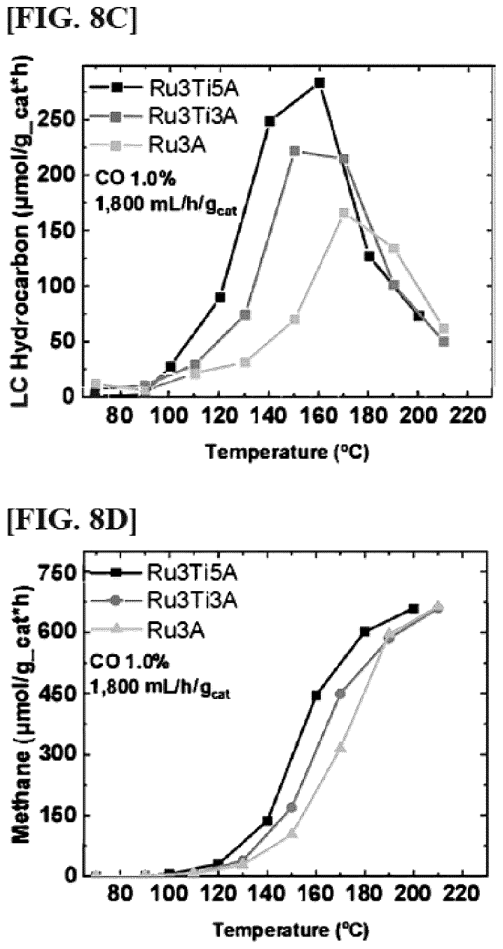

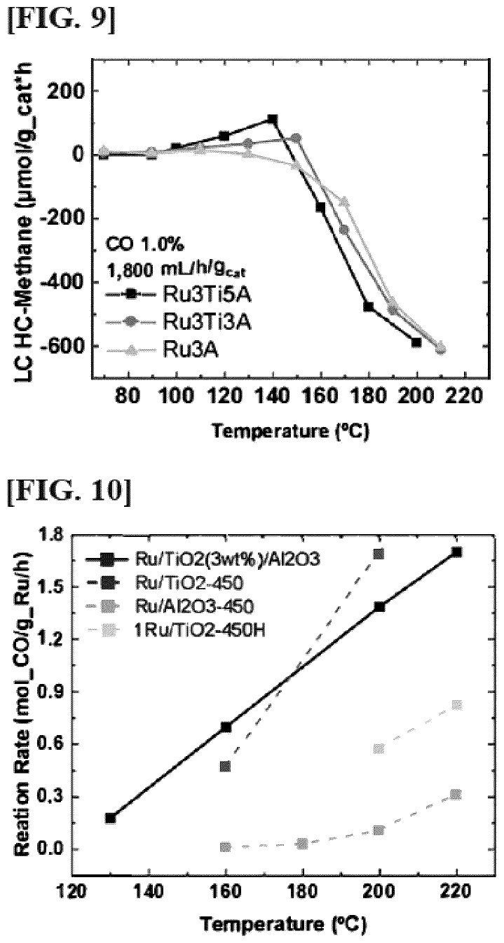

As can be seen in FIGS. 8A to 8D and 9, the catalysts of Examples 1 and 2 showed higher conversion rates of carbon monoxide and decomposition reaction rates of carbon monoxide at a low temperature, compared to the catalyst of Comparative Example 1, which shows a high catalytic activity at the low temperature reaction. In addition, the catalysts of Examples 1 and 2 were found to decompose carbon monoxide at a low temperature and produce a long-chain hydrocarbon of C₅ or more at a very high rate. It was confirmed that the CO decomposition reaction was well performed in the low temperature region even when the CO content increases in the reformed gas, and that as an amount of the transition metal oxide increases, it provides higher reaction activity and higher selectivity for the long-chain hydrocarbon at a low temperature.

### Experimental Example 4. Purification Reaction of Carbon Monoxide

A purification reaction of carbon monoxide contained in a reformed gas was performed using the catalysts obtained in Example 1 and Comparative Examples 3 to 5 as follows.

Specifically, the reformed gas having a composition of 32% CO/4% H₂/64% N₂ was reacted with 0.3 g of the catalyst in a plug flow reactor while changing a temperature under conditions of a space velocity of 3,000 mL/h/g_{cat} and a pressure of 2.0 Mpa. Experimental results were calculated from the gas composition obtained using a gas chromatography (8890GC, Agilent Technologies, USA) which was connected to the reactor.

In FIG. 10, the reaction rate means an amount of reacted and purified carbon monoxide per unit time and per unit Ru mass. It was confirmed that the catalyst of Example 1 was suitable for the low-temperature carbon monoxide purification as it had very excellent reaction activity at a low temperature compared to the catalysts of Comparative Examples 3 to 5.

As mentioned above, specific parts of the present disclosure have been described in detail, and it is clear to those skilled in the art that these specific techniques are merely preferred embodiments and do not limit the scope of the present disclosure. Accordingly, the substantial scope of the present disclosure will be defined by the attached claims and their equivalents.

What is claimed is:

1. A catalyst for purifying carbon monoxide contained in a reformed gas, comprising:
a metal oxide carrier;
a transition metal oxide primarily supported on the carrier; and
ruthenium secondarily supported on a carrier carrying the transition metal oxide.

2. The catalyst for purifying carbon monoxide contained in the reformed gas, according to claim 1,
wherein the metal oxide carrier is one or more selected from the group consisting of silica, alumina, magnesia, titania, and zirconia.

3. The catalyst for purifying carbon monoxide contained in the reformed gas, according to claim 1,
wherein the transition metal oxide is one or more oxides selected from the group consisting of Ti, Ce, Ni, and Rh.

4. The catalyst for purifying carbon monoxide contained in the reformed gas, according to claim 1,
wherein the transition metal oxide is comprised in an amount of 0.1 to 20% by weight based on the total weight of the catalyst.

5. The catalyst for purifying carbon monoxide contained in the reformed gas, according to claim 1,
wherein the ruthenium is comprised in an amount of 0.1 to 20% by weight based on the total weight of the catalyst.

6. The catalyst for purifying carbon monoxide contained in the reformed gas, according to claim 1,
wherein the reformed gas comprises 0.0001 to 32 vol % of carbon monoxide based on the total volume of the reformed gas, hydrogen in a volume fraction equivalent to twice or more the volume fraction of carbon monoxide, and 95 vol % or less of an inert gas other than hydrogen based on the total volume of the reformed gas.

7. The catalyst for purifying carbon monoxide contained in the reformed gas, according to claim 1,
wherein the catalyst purifies carbon monoxide contained in the reformed gas at 80 to 180° C.
